(19) United States
(12) Patent Application Publication
(10) Pub. No.: US 2024/0425695 A1
(43) Pub. Date: Dec. 26, 2024

(54) TWO-COMPONENT EPOXY RESIN AMINE FUNCTIONALIZED LATEX COMPOSITION

(71) Applicants: Dow Global Technologies LLC, Midland, MI (US); Rohm and Haas Company, Collegeville, PA (US)

(72) Inventors: Yanxiang Li, Midland, MI (US); Ray E. Drumright, Midland, MI (US); Zhenwen Fu, Norristown, PA (US); Andrew Hejl, Lansdale, PA (US); Denise Lindenmuth, Ambler, PA (US)

(21) Appl. No.: 18/687,159

(22) PCT Filed: Aug. 19, 2022
(86) PCT No.: PCT/US2022/040830

§ 371 Date: Feb. 27, 2024

Related U.S. Application Data
(63) Continuation of application No. 63/243,305, filed on Sep. 13, 2021.

(51) Int. Cl. C08L 63/00; C08K 5/1515

(52) U.S. Cl. CPC C08L 63/00; C08K 5/1515; C08L 2201/52; C08L 2201/54

(57) ABSTRACT

The present invention relates to a composition comprising an aqueous dispersion of a thermosettable compound and polymer particles functionalized with aminoalkyl ester groups. The composition is useful as a two-component waterborne curing system and is effective in providing corrosion and blister resistance in industrial coatings applications.

### BACKGROUND OF THE INVENTION

The present invention relates to a two-component composition comprising an epoxy resin and a latex functionalized with amine groups. The composition is useful for coating substrates, especially metal surfaces, in industrial coatings applications.

Two-component waterborne curable compositions for industrial applications include an epoxy resin and a curing agent, typically a polyamine or a carboxylic acid functionalized latex, which acts as a crosslinking agent to provide hardness for the coating after it is applied to a substrate. Carboxylic acid functionalized acrylic latexes provide UV-stable coatings with concomitant resistance to yellowing but require long curing times and form coatings with relatively poor corrosion resistance. Polyamine curing agents, on the other hand, cure rapidly and offer relatively acceptable corrosion resistance, but poor UV resistance.

It would therefore be an advantage in the art of two-component waterborne epoxy resin compositions to discover a formulation that provides fast curing times, UV resistance, and corrosion resistance.

### SUMMARY OF THE INVENTION

The present invention addresses a need in the art by providing a composition comprising an aqueous dispersion of a) a thermosettable compound; and b) polymer particles functionalized with aminoalkyl ester groups of the type:

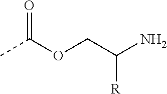

where R is H or C₁-C₆-alkyl.

The composition of the present invention is useful as a two-component waterborne curing system that is especially effective in industrial coatings applications.

### DETAILED DESCRIPTION OF THE INVENTION

The present invention is a composition comprising an aqueous dispersion of a) a thermosettable compound; and b) polymer particles functionalized with aminoalkyl ester groups of Structure I:

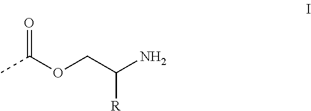

where R is H or C₁-C₆-alkyl.

As used herein, the term “thermosettable compound refers to one or more compounds functionalized with at least two oxirane groups. Examples of classes of suitable thermosettable compounds including epoxy novolac resins, di-, tri- or tetraglycidyl ethers, and di-, tri, or tetraglycidyl esters. Examples of compounds with at least two oxirane groups include the diglycidyl ether of bisphenol A, the diglycidyl ether of bisphenol F, 1,4-butanediol diglycidyl ether, 1,6-hexanediol diglycidyl ether, the diglycidyl ester of phthalic acid, 1,4-cyclohexanedmethanol diglycidyl ether, 1,3-cyclohexanedmethanol diglycidyl ether, the diglycidyl ester of hexahydrophthalic acid, and epoxy novolac resins, and combinations thereof, and aqueous dispersions thereof. A commercially available thermosettable compound is D.E.R.™ 331 Liquid Epoxy Resin (a Trademark of The Dow Chemical Company or its Affiliates).

In one aspect, the thermosettable compound is incorporated (imbibed) into polymer particles dispersed in water (latex particles) to form an acrylic-epoxy hybrid (AEH). In a preferred AEH, the thermosettable compound is completely, or nearly completely incorporated in the latex particles, with less than 1 weight percent free thermosettable compound remaining in the aqueous phase. Examples of suitable latexes include acrylic, styrene-acrylic, styrene-butadiene, urethane, ester, olefin, vinyl chloride, ethylene vinyl acetate, and polyvinyl acetate-based latexes, with acrylic and styrene-acrylic latexes being preferred. The polymer particles preferably have an average particle size as measured by dynamic light scattering in the range of from 80 nm, preferably from 150 nm to 500 nm, preferably to 350 nm.

Monomers suitable for the preparation of acrylic latexes include methyl acrylate, ethyl acrylate, butyl acrylate, 2-ethylhexyl acrylate, methyl methacrylate, ethyl methacrylate, butyl methacrylate, 2-ethylhexyl methacrylate, cyclohexyl methacrylate, t-butyl methacrylate, cyclohexyl acrylate, t-butyl acrylate, and combinations thereof.

The polymer particles that incorporate the thermosettable compound are further characterized by containing anti-agglomerating functional groups, which refer to hydrophilic groups that are sufficiently unreactive with the oxirane groups (and ester groups, if present) such that the latex particles are heat-age stable at 60° C. for 10 days. The term “heat-age stable at 60° C. for days” is used herein to mean that the particle size of a latex subjected to heat-aging at 60° C. for 10 days stability does not increase by more than 30% beyond the particle size before such heat-age studies. The concentration of incorporated thermosettable compound in the polymer particles are typically in the range of from 15, or from 20, or from 25, or from 30, to 60, or to 55 weight percent, based on the weight of the thermosettable compound and the polymer particles.

Anti-agglomerating functional groups can be incorporated into the polymer particles using monomers containing anti-agglomerating functional groups (anti-agglomerating monomers), although it would also be possible to incorporate such groups by grafting. The anti-agglomerating groups are believed to be effective because they are hydrophilic as well as non-reactive with oxirane groups under heat-age conditions. The general class of such groups includes amide groups, acetoacetoxy groups, and strong protic acids having a pKₐ less than 4, which are pH adjusted to form their conjugate bases.

Specific examples of anti-agglomerating monomers include acrylamide, phosphoethyl methacrylate, sodium styrene sulfonate, acetoacetoxyethyl methacrylate, and acrylamido-methyl-propane sulfonate. The corresponding anti-agglomerating functional groups formed from these monomers (also referred to as structural units) are illustrated below:
Anti-agglomerating monomer
Anti-agglomerating functional group
Acrylamide

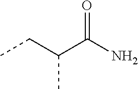

Phosphoethyl methacrylate

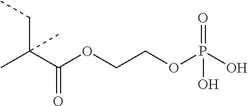

Sodium p-styrene sulfonate

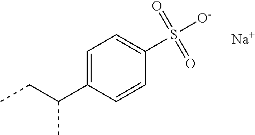

Acetoacetoxyethyl methacrylate

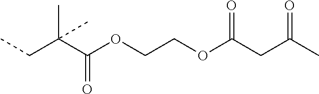

Acrylamido-methyl-propane sulfonic acid

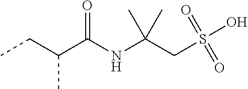

The dotted lines refer to the points of attachment of the anti-agglomerating functional monomer to the polymer. It should be noted that the phosphoethyl methacrylate and acrylamido-methyl-propane sulfonic acid groups are preferably predominantly present in their conjugate base form (i.e., salt form). Preferred anti-agglomerating groups are phosphoethyl methacrylate salt groups. 5

The concentration of anti-agglomerating functional groups in the latex particles is typically in the range of from 0.5 or from 1 weight percent, to 10 or to 5 weight percent, based on the weight of the polymer particles. These particles may contain some amount of carboxylic acid containing functional groups, which are not anti-agglomerating, provided the concentration is sufficiently low so as not to disrupt heat age stability of these particles. Preferably, the concentration of carboxylic acid functionalization in polymer particles with anti-agglomerating functional groups is less than 5 or less than 3 or less than 1 weight percent, based on the weight of the polymer particles with anti-agglomerating functional groups.

Although not bound by theory, it is believed that anti-agglomerating groups are effective in stabilizing the polymer because the groups are both hydrophilic and non-reactive toward epoxy groups under heat-age conditions. Where the anti-agglomerating groups arise from monomers containing strong protic acid groups (phosphoethyl methacrylate, sodium styrene sulfonate, and acrylamido-methyl-propane sulfonate), it has been discovered that colloidal and heat-age stability is achieved by adjusting the pH of the latex to a level above the first pKₐ of a polyprotic acid (such as phosphoethyl methacrylate) or above the pKₐ of a monoprotic acid (such as styrene sulfonic acid and acrylamido-methyl-propane sulfonic acid). If the pH is too low, acid catalyzed oxirane ring opening can occur—at higher pH, such a mechanism is not available, and the conjugate base is non-nucleophilic under heat-age conditions.

The dispersion of polymer particles is advantageously combined with the thermosettable compound as described in U.S. Pat. No. 8,658,742 B2, column 8, lines 48-67.

The dispersion of polymer particles functionalized with aminoalkyl ester groups of Structure I is advantageously prepared in two steps. In a first step, an aqueous dispersion of polymer particles functionalized with carboxylic acid groups (carboxylic acid functionalized latex) is prepared. The carboxylic acid functionalized latex is preferably an acrylic latex or styrene-acrylic latex that comprises, in addition to structural units of one or more acrylates and methacrylates (including those listed above), and/or styrene, structural units of a carboxylic acid monomer such as acrylic acid, methacrylic acid, or itaconic acid. As used herein, the term “structural unit” of the named monomer, refers to the remnant of the monomer after polymerization. For example, a structural unit of methacrylic acid is as illustrated:

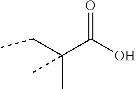

structural unit of methacrylic acid
   where the dotted lines represent the points of attachment of the structural unit to the polymer backbone.

In a second step, the carboxylic acid functionalized latex is contacted with a cyclic imine to form the aqueous dispersion of polymer particles functionalized with aminoalkyl ester groups of Structure I:

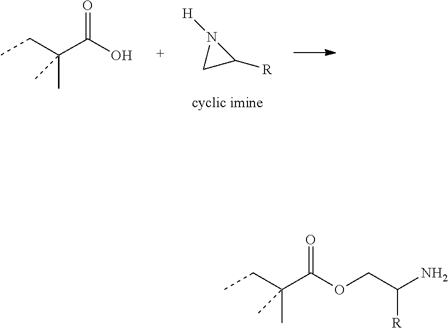

where R is H or C₁-C₆-alkyl; preferably H or methyl.

The dispersion of polymer particles functionalized with aminoalkyl ester groups (the aminoalkyl ester functionalized latex) is preferably functionalized with both aminoalkyl ester groups and carboxylic acid groups or salts thereof; and optionally functionalized with monomers containing strong protic acid groups as described hereinabove. The mole: mole ratio of aminoalkyl ester groups to carboxylic acid groups or salter thereof is typically in the range of from 95:5, or from 80:20, to 5:95, or to 30:70, or to 55:45.

A composition comprising a dispersion of polymer particles functionalized with aminoalkyl ester groups (Component A) is contacted with the thermosettable compound dispersed in the aqueous medium or a composition comprising the AEH (Component B), to form a two-component thermosettable composition. Component A may further include other materials such as opacifying pigments, defoamers, coalescents, surfactants, adhesion promoters, rheology modifiers, solvents, and colorants. Component B, when used in the form of an AEH, may comprise additional materials selected from the same list as Component A.

It has been discovered that coatings prepared from the two-component mixture exhibit superior corrosion and blister resistance as compared with two-component compositions that do not comprise polymer particles functionalized with aminoalkyl ester groups.

### EXAMPLES

### Intermediate Example 1—Preparation of Acrylic-Epoxy Hybrid Dispersion

A styrene-acrylic latex (46.0% solids, ethylhexyl acrylate/styrene/methyl methacrylate/acrylonitrile/phosphoethyl methacrylate latex, with a Tg of 40° C. as measured by differential scanning calorimetry and a z-average particle size of 130 nm as measured by dynamic light scattering) was added to a 5-L, four-necked round bottom flask (kettle) equipped with a paddle stirrer, thermometer, N₂ inlet, and reflux condenser. The latex was heated to 60° C. under N₂. An epoxy emulsion was prepared by mixing DI water (314.53 g), Disponil AFX 4070 Surfactant (70%, 120 g) and D.E.R. 331 Liquid Epoxy Resin (800 g). The emulsion was stirred with an overhead stirrer for 10 min and then homogenized for 60 s using a Cat X520 handheld homogenizer (16,000 rpm). The epoxy emulsion was added to the kettle over 2 min and rinsed with DI water (234 g). The contents of the kettle were agitated for 60 min then cooled to room temperature and filtered to remove any coagulum. The resulting hybrid dispersion had a solids content of 51.9%, a pH of 7.2 and a particle size of 147 nm.

### Intermediate Example 2—Preparation of Dispersion of Carboxylic Acid Functionalized Latex

DI water (1363.05 g), Disponil FES-32 Surfactant (FES-32, 31% active, 8.82 g), and 4-hydroxy-TEMPO (5%, 0.45 g) were added to a 5-L, four-necked round bottom flask (kettle) equipped with a paddle stirrer, thermometer, N₂ inlet, and reflux condenser. The kettle was heated to 85° C. under N₂. A monomer emulsion (ME) was prepared by mixing DI water (440.64 g), FES-32 (31%, 44.09 g), 2-ethylhexyl acrylate (EHA, 686.19 g), methyl methacrylate (MMA, 568.80 g), styrene (451.44 g), and methacrylic acid (MAA, 72.23 g). A portion of the monomer emulsion (3%, 68.45 g) was charged to the kettle and rinsed with DI water (20 g). A solution of ammonium persulfate (APS, 6.36 g in 40 g DI water) was added to the kettle and rinsed with DI water (10 g). An exotherm was observed and allowed to hold at the peak temperature for 5 min. The remainder of the ME was fed to the kettle over 120 min with the temperature set to 85° C. with the first 20 min at 50% rate. Concurrently a solution of APS (2.73 g in 120 g DI water) was fed over 120 min with the first 20 min at 50% rate. At the completion of feeds, the addition vessels were rinsed with DI water (90 g) and the reaction was cooled to 70° C. While cooling, a solution of iron sulfate heptahydrate (0.15% solution, 12.12 g) and VERSENE™ Chelating Agent (1.0% solution, 1.90 g, a Trademark of The Dow Chemical Company or its Affiliates) was added to the kettle. At 70° C. a chase solution of t-butyl hydroperoxide (1-BHP, 70% solution, 3.13 g in 40 g DI water) was added to the kettle, concurrent with a solution of isoascorbic acid (IAA, 2.19 g in 40 g DI water) over 30 min. After the completion of the chaser addition, the reaction mixture was neutralized to pH 7 by addition of ammonium hydroxide (30%, 26.50 g). The contents of the kettle were then cooled to room temperature and filtered to remove any coagulum. The resulting dispersion had a solids content of 44.9%, a pH of 7.1 and a particle size of 85 nm.

### Intermediate Example 3—Preparation of Dispersion of Carboxylic Acid Functionalized Latex

DI water (1363.05 g), FES-32 (31%, 8.82 g), and 4-hydroxy-TEMPO (5%, 0.45 g) were added to a 5-L, four-necked round bottom flask (kettle) equipped with a paddle stirrer, thermometer, N₂ inlet, and reflux condenser. The kettle was heated to 85° C. under N₂. An ME was prepared by mixing DI water (440.64 g), FES-32 (31%, 44.09 g), EHA (704.25 g), MMA (M478.51 g), styrene (451.44 g), and MAA (144.46 g). A portion of the ME (3%, 68.45 g) was charged to the kettle and rinsed with DI water (20 g). A solution of APS (6.36 g in 40 g DI water) was added to the kettle and rinsed with DI water (10 g). An exotherm was observed and allowed to hold at the peak temperature for 5 min. The remainder of the ME was fed to the kettle over 120 min with the temperature set to 85° C. with the first 20 min at 50% rate. Concurrently a solution of APS (2.73 g in 120 g DI water) was fed over 120 min with the first 20 min at 50% rate. At the completion of feeds, the addition vessels were rinsed with DI water (90 g) and the reaction was cooled to 70° C. While cooling, a solution of iron sulfate heptahydrate (0.15% solution, 12.12 g) and VERSENE™ Chelating Agent (1.0% solution, 1.90 g) was added to the kettle. At 70° C. a chase solution of t-BHP, 70% solution, 3.13 g in 40 g DI water) was added to the kettle, concurrent with a solution of IAA (2.19 g in 40 g DI water) over 30 min. After the completion of the chaser addition, the reaction mixture was neutralized to pH 7 by addition of ammonium hydroxide (30%, 24.50 g). The contents of the kettle were then cooled to room temperature and filtered to remove any coagulum. The resulting dispersion had a solids content of 44.7%, a pH of 7.0 and a particle size of 84 nm.

### Intermediate Example 4—Preparation of Dispersion of Amine Functionalized Latex (50:50)

Intermediate Example 2 (1000 g, 0.209 mol MAA) was charged into a reactor fitted with a stirrer, a thermometer, a condenser, and an addition funnel. Propyleneimine (19.85 g, 30 wt % in water, 0.104 mol) was added over 10 min to the reactor with stirring at 25° C. The mixture was heated to 50° C. over 30 min, and the reaction temperature was maintained at 50° C. for 60 min. The temperature of the reactor was then increased to 80° C. and maintained at this temperature for 60 min. The reactor was then gradually cooled to 25° C. The dispersion product had a mole: mole ratio of amine to carboxylic acid functionalization of 50:50, and a solids content of 44.6%.

### Intermediate Example 5—Preparation of Dispersion of Amine Functionalized Latex (75:25)

The process for preparing Intermediate 4 was repeated except that 29.77 g of propyleneimine was used. The dispersion product had a mole: mole ratio of amine to carboxylic acid functionalization of 75:25, and a solids content of 44.4%.

### Intermediate Example 6—Preparation of Dispersion of Amine Functionalized Latex (50:50)

Intermediate Example 3 (1000 g, 0.209 mol MAA) was charged into a reactor fitted with a stirrer, a thermometer, a condenser, and an addition funnel. Propyleneimine (39.57 g, 30 wt % in water, 0.104 mol) was added over 10 min to the reactor with stirring at 25° C. The mixture was heated to 50° C. over 30 min, and the reaction temperature was maintained at 50° C. for 60 min. The temperature of the reactor was then increased to 80° C. and maintained at this temperature for 60 min. The reactor was then gradually cooled to 25° C. The dispersion product had a mole: mole ratio of amine to carboxylic acid functionalization of 50:50, and a solids content of 44.2%.

Table 1 shows the two-component formulation using Intermediate 2 and amine functionalized derivatives thereof (Intermediates 4 and 5). Part A formulations containing Intermediate 2 (no amine functionalization) are Comparative Examples 1 and 2. Part A formulations containing Intermediate 4 are Examples 1 and 2, and Part A formulation containing Intermediate Example 5 is Example 3.

TABLE 1
Two-component Formulation

| | Comparative Examples | | Inventive Examples | | |
|---|---|---|---|---|---|
| | 1 | 2 | 1 | 2 | 3 |
| Formulation | (g) | (g) | (g) | (g) | (g) |
| Part A Components | | | | | |
| Intermediate 2 | 22.83 | 26.18 | | | |
| Intermediate 4 | | | 19.91 | 24.05 | |
| Intermediate 5 | | | | | 18.80 |
| Deaerator | 1.47 | 1.47 | 1.47 | 1.47 | 1.47 |
| Pigment Grind A | 12.79 | 12.79 | 12.79 | 12.79 | 12.79 |
| Glycol Ether | 0.42 | 0.41 | 0.44 | 0.43 | 0.44 |
| Coalescent | 0.25 | 0.24 | 0.25 | 0.24 | 0.25 |
| Sodium Nitrite 15% | 0.45 | 0.45 | 0.45 | 0.45 | 0.45 |
| Surfactant | 0.03 | 0.03 | 0.03 | 0.03 | 0.03 |
| DI Water | 0.52 | 0.40 | 0.62 | 0.27 | 0.67 |
| Rheology Modifier | 0.15 | 0.15 | 0.15 | 0.15 | 0.15 |
| Adhesion Promoter | 0.14 | 0.09 | 0.18 | 0.13 | 0.20 |
| Total Part A | 39.05 | 42.21 | 36.31 | 40.02 | 35.27 |
| Part B | | | | | |
| Intermediate 1 | 9.35 | 6.08 | 12.08 | 8.22 | 13.18 |
| Total Formulation | 48.40 | 48.29 | 48.38 | 48.24 | 48.44 |

Deaerator refers to Tego Airex 902w Deaerator; Glycol Ether refers to DOWANOL™ DPnB Glycol Ether; Coalescent refers to Optifilm 400 Coalescent; Surfactant refers to TRITON™ HW1000 Surfactant; Rheology Modifier refers to ACRYSOL™ RM-12W Rheology Modifier; Adhesion Promoter refers to XIAMETER™ OFS-6020 Adhesion Promoter; (DOWANOL, TRITON, ACRYSOL, and XIAMETER are all Trademarks of The Dow Chemical Company or Its Affiliates). Pigment Grind A is prepared by mixing components shown in Table 2:

TABLE 2
Pigment Grind A

| Pigment Grind A | |
|---|---|
| Component | Wt % |
| Deionized Water | 17% |
| Glycol Ether | 10.91% |
| Coalescent | 3.97% |
| Ammonia (28%) | 0.66% |
| Defoamer | 0.43% |
| Dispersant | 2.73% |
| Surfactant | 0.57% |
| Ti-Pure R-706 TiO₂ | 63.73% |
| Total | 100% |

Defoamer refers to Tego Foamex 1488 Defoamer; Dispersant refers to TAMOL™ 681 Dispersant; and TiO₂ refers to Ti-Pure R-706 TiO₂;

Table 3 shows the two-component formulation using Intermediate 3 and an amine functionalized derivative thereof (Intermediate 6). Part A formulations containing Intermediate 3 (no amine functionalization) are Comparative Examples 3 and 4. Part A formulations containing Intermediate 6 are Examples 4 and 5.

TABLE 3
Two-Component Formulation

| | |
|---|---|
| Comparative Examples | Examples |

| | 3 | 4 | 4 | 5 |
|---|---|---|---|---|
| Formulation | (g) | (g) | (g) | (g) |
| Part A Component | | | | |
| Intermediate 3 | 17.45 | 21.90 | | |
| Intermediate 6 | | | 14.54 | 19.25 |
| Deaerator | 1.47 | 1.47 | 1.47 | 1.47 |
| Pigment Grind A | 12.79 | 12.79 | 12.79 | 12.79 |
| Glycol Ether | 0.43 | 0.42 | 0.44 | 0.42 |
| Coalescent | 0.26 | 0.25 | 0.26 | 0.25 |
| Sodium Nitrite 15% | 0.45 | 0.45 | 0.45 | 0.45 |
| Surfactant | 0.03 | 0.03 | 0.03 | 0.03 |
| DI Water | 1.02 | 0.70 | 1.07 | 0.67 |
| Rheology Modifier | 0.15 | 0.15 | 0.15 | 0.15 |
| Adhesion Promoter | 0.22 | 0.15 | 0.26 | 0.20 |
| Total Part A | 34.28 | 38.31 | 31.47 | 35.69 |
| Part B: | | | | |
| Intermediate 1 | 14.34 | 10.14 | 17.23 | 12.86 |
| Total Formulation | 48.62 | 48.46 | 48.71 | 48.55 |

### Salt Fog Corrosion Resistance

ASTM Method B117 4 was used to conduct salt fog resistance. This test is designed to determine the corrosion resistance of coatings by exposing a coated panel to a dilute salt solution fog. The coatings were applied on phosphated treated steel panels with dry coating thickness at 2 to 3 mils and cured under ambient condition for at least 7 d before the testing. The cured coated panels were first tape wrapped on the back side and edges and an “X” cut was scribed through the coating to the substrate. The panels were then exposed in the salt fog chamber. For each formulation, two coated panels were evaluated after a 500-h exposure. ASTM D714 was used to measure field blister and scribe blister. For blister rating, the number indicates the size scale of the blisters from 0 to 10, where 10 represents no blistering and 0 the most extreme blistering. A rating of 8 represents the smallest blister size readily visible to the unaided eye. Letter suffixes in blister ratings show the frequency, as follows: D=Dense; MD=Medium dense; M=Medium; F=Few. ASTM D610 was used to measure corrosion resistance. The rating number indicates the spot rusting level on the unscribed area of the panel, where 10 represents no spot rusting, and 0 the most extreme rusting. Table 4 illustrates salt fog rating for coatings prepared from the example and comparative example formulations from Table 1.

TABLE 4
Salt Fog Rating for Formulations

| | Comparative Examples | | Examples | | |
|---|---|---|---|---|---|
| | 1 | 2 | 1 | 2 | 3 |
| Field blisters | 6F | 6F | 10 | 10 | 10 |
| Scribe blisters | 4D | 2D | 8M | 8F | 8M |
| Field corrosion | 9 | 7 | 10 | 10 | 9 |

Table 5 illustrates salt fog rating for coatings prepared from the example and comparative example formulations from Table 3.

TABLE 5
Salt Fog Rating for Formulations

| | |
|---|---|
| Comparative Examples | Examples |

| | 3 | 4 | 4 | 5 |
|---|---|---|---|---|
| Field Blisters | 6F | 6F | 10 | 10 |
| Scribe blisters | 2D | 2D | 8M | 8M |
| Field Corrosion | 9 | 8 | 10 | 10 |

The data illustrate the improvements seen in field corrosion and especially in field and scribe blisters for the formulations containing the amine-functionalized binder.

1. A composition comprising an aqueous dispersion of a) a thermosettable compound; and b) polymer particles functionalized with aminoalkyl ester groups of the type: 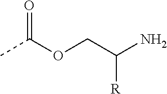
where R is H or C₁-C₆-alkyl.

2. The composition of claim 1 wherein the thermosettable compound is a epoxy novolac resin or a di-, tri- or tetraglycidyl ether or a di-, tri- or tetraglycidyl ester or a combination thereof.

3. The composition of claim 1 wherein the thermosettable compound is a diglycidyl ether, which is the diglycidyl ether of bisphenol A, the diglycidyl ether of bisphenol F, 1,4-butanediol diglycidyl ether, or 1,6-hexanediol diglycidyl ether or a combination thereof.

4. The composition of claim 1 wherein the thermosettable compound is the diglycidyl ether of bisphenol A, which is incorporated into latex polymer particles functionalized with anti-agglomerating groups; wherein the concentration of incorporated diglycidyl ether of bisphenol A in the latex polymer particles is in the range of from 15 to 60 weight percent, based on the weight of the thermosettable compound and the latex polymer particles.

5. The composition of claim 1 wherein R is CH₃.

6. The composition of claim 1 wherein the polymer particles functionalized with aminoalkyl ester groups are also functionalized with carboxylic acid groups or salts thereof, wherein the mole: mole ratio of aminoalkyl ester groups to carboxylic acid groups or salts thereof is in the range of from 95:5 to 5:95.

7. The composition of claim 5 wherein the polymer particles functionalized with aminoalkyl ester groups are also functionalized with carboxylic acid groups or salts thereof, wherein the mole: mole ratio of aminoalkyl ester groups to carboxylic acid groups or salts thereof is in the range of from 80:20 to 45:55.

8. The composition of claim 7 wherein the polymer particles functionalized with aminoalkyl ester groups are also functionalized with monomers containing strong protic acid groups or salts thereof.

9. The composition of claim 7 wherein the polymer particles functionalized with aminoalkyl ester groups are also functionalized with phosphoethyl methacrylate or a salt thereof.

10. The composition of claim 2 where R is CH₃.

11. The composition of claim 3 where R is CH₃.

12. The composition of claim 4 where R is CH₃.
